(19) United States
(12) Patent Application Publication
(10) Pub. No.: US 2004/0206528 A1
(43) Pub. Date: Oct. 21, 2004

(54) CONNECTION CABLE

(76) Inventors: Rong-Wha Wu, Yun-Lin Hsien (TW); Shih-Hsiu Huang, Tao-Yuan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/708,945

(22) Filed: Apr. 2, 2004

(30) Foreign Application Priority Data
Apr. 17, 2003 (TW) 092109001

(51) Int. Cl. H01B 7/29

(52) U.S. Cl. 174/36

(57) ABSTRACT

A connection cable includes a connector having a first set of pins, a second set of pins, a third set of pins, and a fourth set of pins. The connection cable further includes a first set of transmission lines connected to the first set of pins, a second set of transmission lines connected to the second set of pins, a third set of transmission lines connected to the third set of pins, and a fourth set of transmission lines connected to the fourth set of pins. In addition, the connection cable has an audio connector connected to the first set of transmission lines, a component video signal connector connected the second set of transmission lines, a s video signal connector connected to the third set of transmission lines, and a composite video signal connector connected to the fourth set of transmission lines. The connector is a d-sub type connector.

### BACKGROUND OF INVENTION

1. Field of the Invention

The present invention relates to a connection cable, and more particularly, to a connection cable capable of integrating audio and video signals.

2. Description of the Prior Art

A variety of modern Audio/Video (A/V) device and display devices are introduced to the market, and more and more types of connection cables for transmitting audio as well as video signals from an A/V device to a display device enter the market accordingly. Common Inputs/Outputs (I/Os) of the A/V device or the display device include a S video Input/Output (I/O), a component video I/O, both for transmitting video signals, and an A/V I/O for transmitting video signals and audio signals. A composite video signal is usually generated by an image-forming device by divided lights into red, blue and green signals, and transformed into (a) a luminance signal (Y), indicating luminance part of the composite video signal, and (b) a chrominance signal, indicating chrominance part of the composite video signal. The chrominance signal can be further divided into a C_{b} and a Cᵣ (or Pᵣ and P_{b}) signal. The luminance signal (Y), C_{b} signal, and Cᵣ signal all can be transmitted via the component video I/O. When the Cᵣ signal is mixed with the C_{b} signal to form a mixed signal, the mixed signal can be transmitted via the S video I/O. Further mixed with the luminance signal (Y) to form a composite video signal, the composite video signal can be transmitted via the video I/O of the A/V I/O. Therefore, the image transmitted via the S video I/O is better than that via the A/V I/O, and the image transmitted via the component video I/O is superior to that via the S video I/O.

Please refer to FIGS. 1 to 3. FIG. 1 is a schematic diagram of an A/V connection cable 10 according to the prior art. FIG. 2 is a schematic diagram of a S video connection cable 12 according to the prior art. FIG. 3 is a schematic diagram of a component video connection cable 14 for transmitting chrominance signals according to the prior art. The A/V connection cable 10 installs itself on each of both ends with a yellow plug for transmitting video signals, and a white and a red plugs both for transmitting audio signals. The white plug is usually for receiving audio-L signals, while the red plug receives audio-R signals instead. In addition, the S cable 12 has two round-shaped plugs, inside which are installed with four pins. The connection of the S video connection cable 12 and the corresponding connector is realized by plugging the pins into the corresponding holes in an unique direction. The component video connection cable 14 is made of six RCA connectors, three on each end. A green RCA connector is for transmitting luminance signals, while the blue and red RCA connectors are for transmitting chrominance signals C_{b} and Cᵣ respectively. Users can follow the color indication to connect the component video connection cable 14.

It can be seen from the above-mentioned that most A/V devices can only meet a variety of users demands by providing a set of signal I/Os for connecting the A/V connection cable, the S video connection cable, and the component video connection cable. That is, the A/V device needs to install a set of I/O ports including three connecting holes for the A/V connection cable, one connecting hole for the S video cable, and another three connecting holes for the component video connection cable. Such I/O ports with seven connecting holes occupy a large space of the A/V device or a display device. In addition, some display devices may install several sets of I/O ports for connecting more than one A/V device simultaneously. Forming several sets of I/O ports may cause great bulk and increase the cost of the display device. In addition, too many connections between A/V devices and display devices result in a mess, and connection errors resulting from too many connections are still inevitable.

### SUMMARY OF INVENTION

It is therefore a primary objective of the claimed invention to provide a connection cable as well as a corresponding connection socket to overcome the drawbacks of the prior art.

According to the claimed invention, the connection cable comprises a connector, comprising a first set of pins, a second set of pins, a third set of pins, and a fourth set of pins. The connection cable further comprises a first set of transmission lines connected to the first set of pins, a second set of transmission lines connected to the second set of pins, a third set of transmission lines connected to the third set of pins, a fourth set of transmission lines connected to the fourth set of pins, an audio signal connector connected to the first set of transmission lines, a component video signal connector connected to the second set of transmission lines, a S video signal connector connected to the third set of transmission lines, and a composite video signal connector connected to the fourth set of transmission lines.

It is an advantage of the claimed invention that a connection cable with an integral end having a plurality of pins compatible to a variety of A/V connection cables reduces not only the bulk of a control panel of an A/V device, but also time for an user to equip these connection cables in order.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of an A/V connection cable according to the prior art.

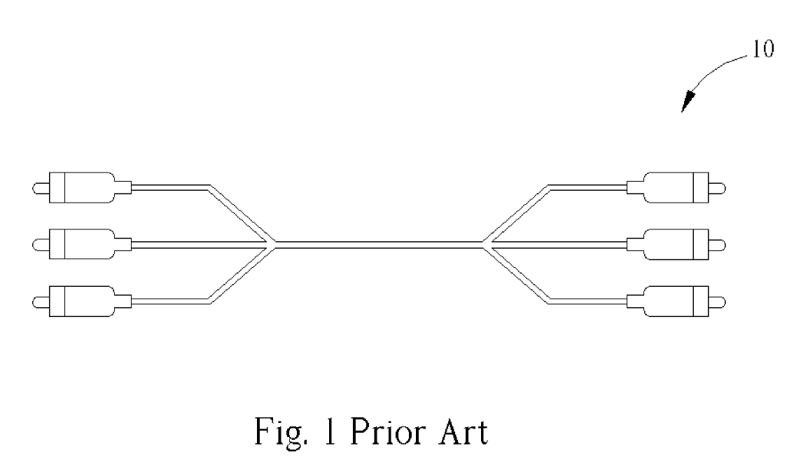

FIG. 2 is a schematic diagram of a S video connection cable according to the prior art.

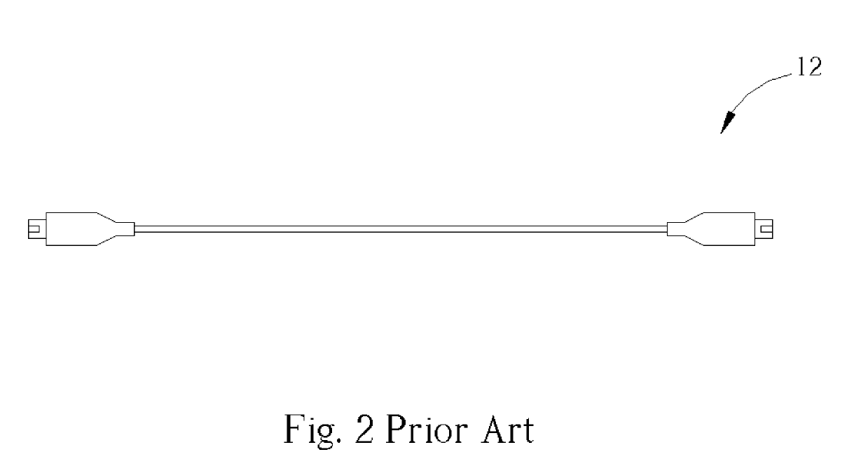

FIG. 3 is a schematic diagram of a component video connection cable according to the prior art.

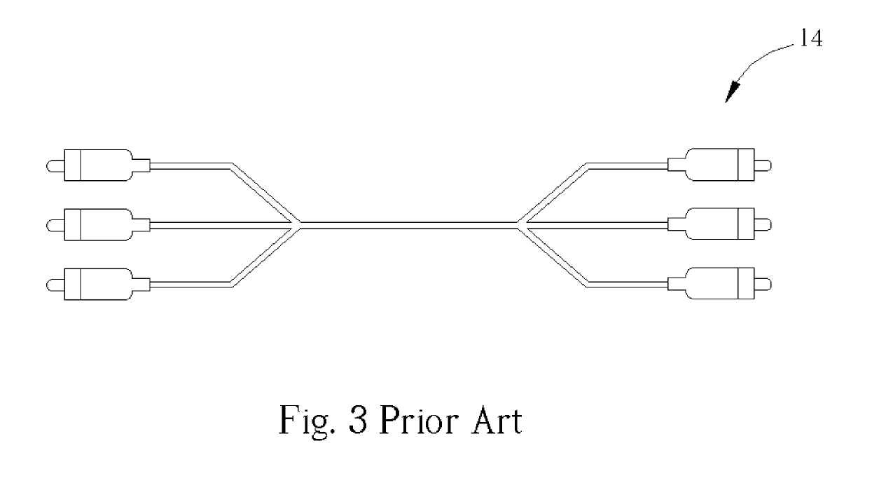

FIG. 4 is a schematic diagram of a preferred embodiment of a connection cable according to the present invention.

FIG. 5 is a schematic diagram of pin disposition of the connection cable shown in FIG. 4 according to the present invention.

FIG. 6 is a schematic diagram of a second embodiment of a connection cable according to the present invention.

FIG. 7 is a schematic diagram of a third embodiment of a connection cable according to the present invention.

FIG. 8 is a schematic diagram of a fourth embodiment of a connection cable according to the present invention.

FIG. 9 is a schematic diagram of a fifth embodiment of a connection cable according to the present invention.

FIG. 10 is a schematic diagram of a sixth embodiment of a connection cable according to the present invention.

FIG. 11 is a schematic diagram of a preferred embodiment of a connection socket for an A/V device according to the present invention.

### DETAILED DESCRIPTION

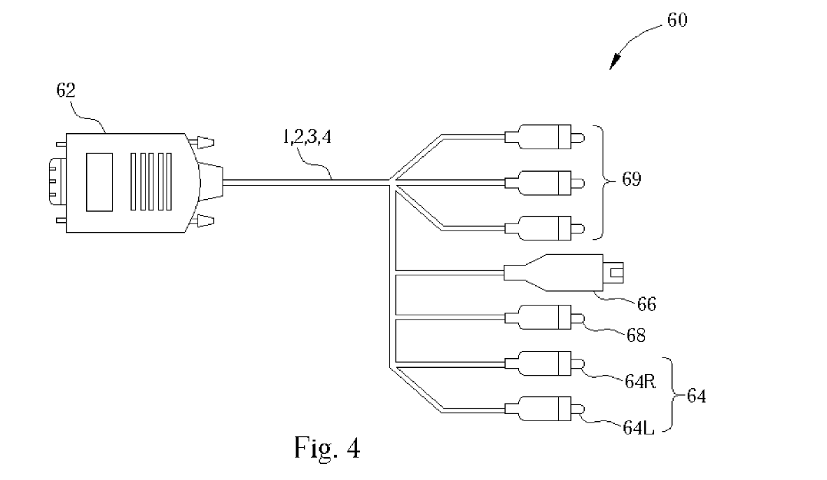

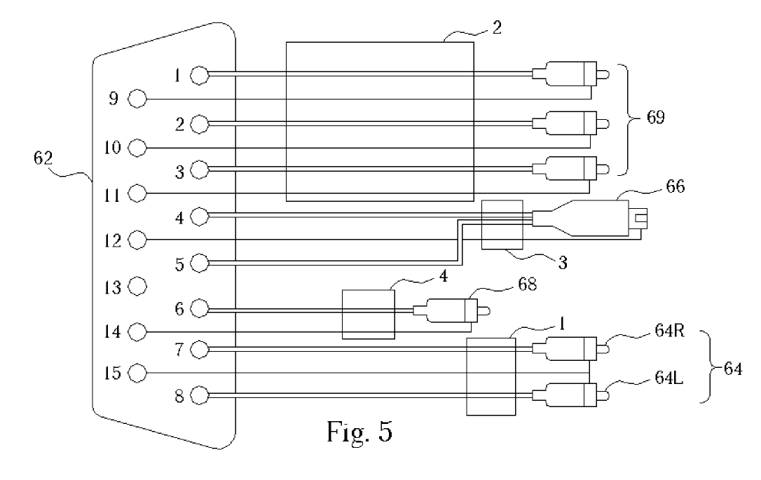

Please refer to FIG. 4 and FIG. 5. FIG. 4 is a schematic diagram of a first embodiment of a connection cable 60 according to the present invention. FIG. 5 is a schematic diagram of pin allocation of a connector 62 shown in FIG. 4. The connection cable 60 comprises the connector 62, a plurality of transmission lines, and a plurality of plugs. The connector 62 is an integral connector and comprises a first set of pins, including pins 7, 8 and 15, a second set of pins, including pins 1, 9, 2, 10, 3 and 11, a third set of pins, including pins 4, 12 and 5, and a fourth set of pins, including pins 6 and 14. In the first embodiment, the connector 62 is a D-sub connector with 15 pins. The connection cable 60 comprises a first set of transmission lines 1 connected to the first set of pins, a second set of transmission lines 2 connected to the second set of pins, a third set of transmission lines 3 connected to the third set of pins, and a fourth set of transmission lines 4 connected to the fourth set of pins, as shown in FIG. 4 and FIG. 5. An audio signal connector 64, which comprises an audio-L connector 64L and an audio-R connector 64R, is connected to the first set of transmission lines 1. A component video signal connector 69 is connected to the second set of transmission lines 2. An S video signal connector 66 is connected to the third set of transmission lines 3. A composite video signal connector 68 is connected to the fourth set of transmission lines 4. The pins 7, 8 and 15 in the first set of pins are connected to two audio signal lines one ground line for the audio-L connector 64L and audio-R connector 64R. Pins 1, 9, 2, 10, 3 and 11 in the second set of pins are connected to a luminance signal line, two chrominance signal lines and three ground lines of the component video signal connector 69 respectively. The pins 4, 12 and 5 in the third set of pins are connected to a luminance signal line, a chrominance signal line and a ground line of the S video signal connector 66 respectively. The pins 6 and 14 in the fourth set of pins are connected to a composite video signal line and a ground line of the composite video signal connector 68. A pin 13 in the connector 62 is not used.

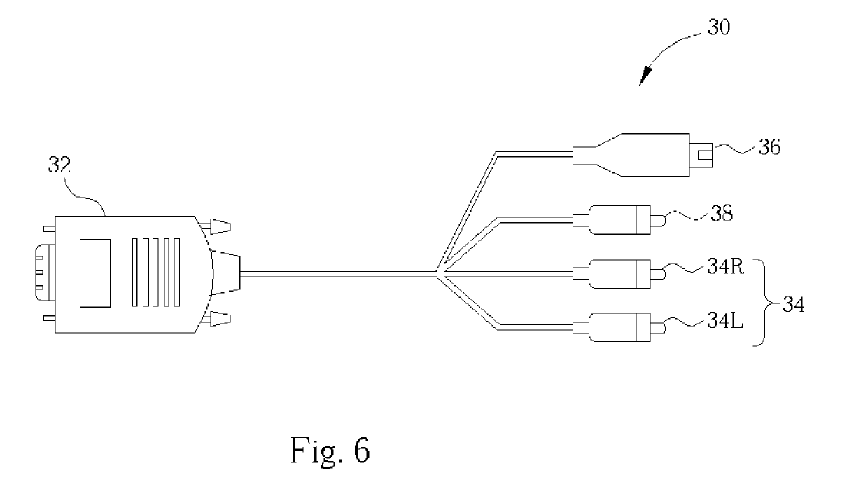

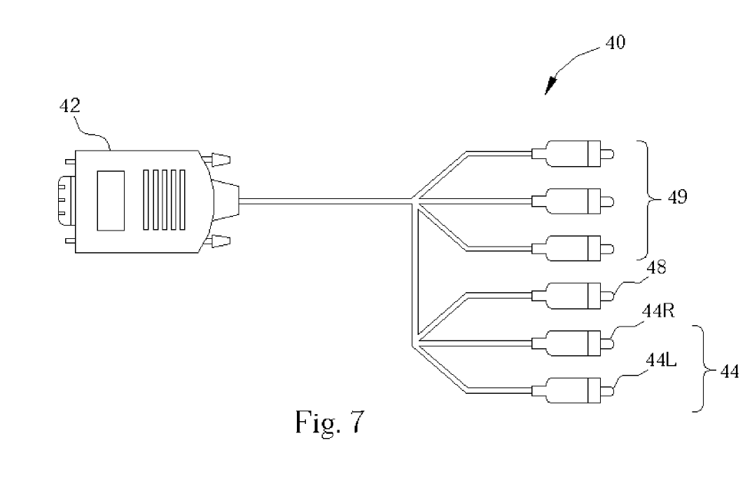

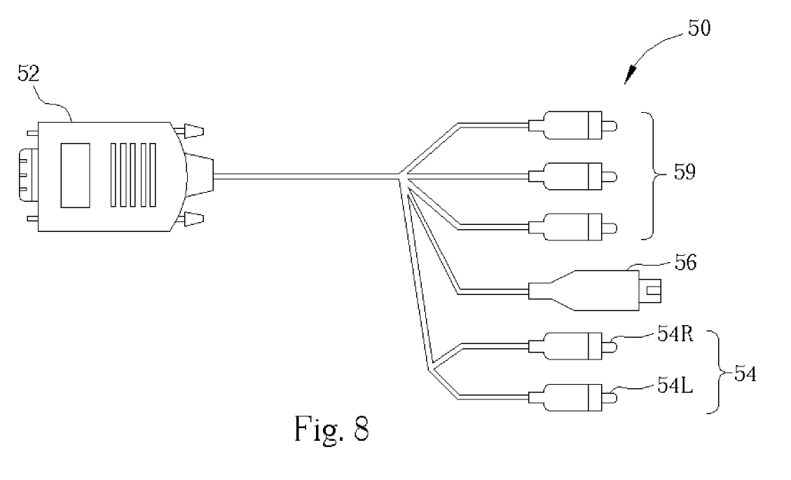

Please refer to FIG. 6 to FIG. 8. FIG. 6 is a schematic diagram of a second embodiment of a connection cable 30 according to the present invention. FIG. 7 is a schematic diagram of a third embodiment of a connection cable 40 according to the present invention. FIG. 8 is a schematic diagram of a fourth embodiment of a connection cable 50 according to the present invention.

Connection cables disclosed in the present invention can transmit audio signals and video signals as well. According to the present invention, a connection cable comprises an integral connector, a plurality of transmission lines, and a plurality of connectors. The integral connector comprises a first set of pins, a second set of pins and a third set of pins. The plurality of transmission lines comprise a first set of transmission lines connected to the first set of pins, a second set of transmission lines connected to the second set of pins, and a third set of transmission lines connected to the third set of pins. The plurality of connectors comprise an audio-L and an audio-R connectors connected to the first set of transmission lines, a first video signal plug connected to the second set of transmission lines, and a second video signal plug connected to the third set of transmission lines.

Please refer to FIG. 6. The connection cable 30 is designed to have an integral connector 32 to be installed on one end of the connection cable 30, and an audio connector 34 and two video signal connectors 36 and 38 to be installed on the other end in order to reduce space for I/O ports of a display device, and to ensure compatibility of a variety of A/V devices and display devices. In this embodiment, the audio connector 34 comprises an audio-L connector 34L and an audio-R connector 34R. The first video signal connector 36 is a S video signal connector for transmitting S video signals. The second video signal connector 38 is a composite video signal connector for transmitting composite video signals.

Please refer to FIG. 7. The connection cable 40 comprises an audio connector 44 and two video signal connectors 48 and 49. The audio connector 44 comprises an audio-L connector 44L and an audio-R connector 44R. The video signal connector 48 is a composite video signal connector for transmitting composite video signals, while the video signal connector 49 is a component video signal connector for transmitting component video signals.

Please refer to FIG. 8. The connection cable 50 comprises an audio connector 54 and two video signal connectors 56 and 59. In the third embodiment, the audio connector 54 comprises an audio-L connector 54L and an audio-R connector 54R. The video signal connector 56 is a S video signal connector for transmitting S video signals, while the video signal connector 59 is a component video signal connector for transmitting component video signals.

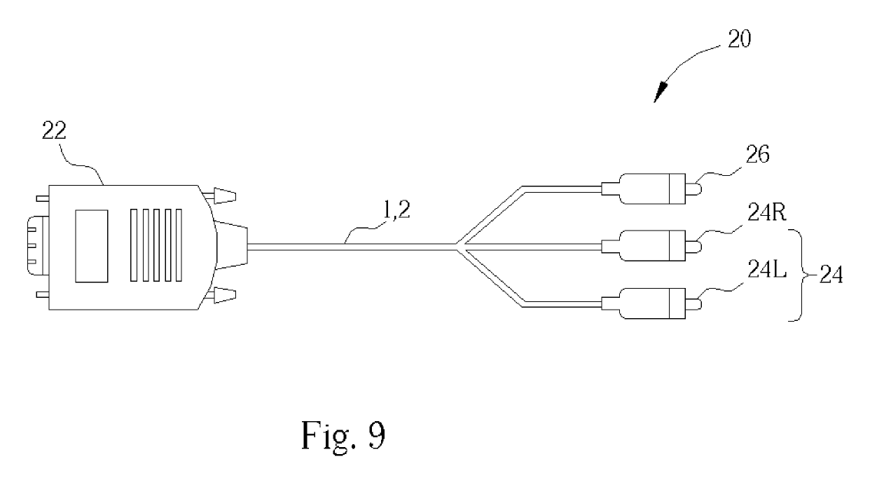

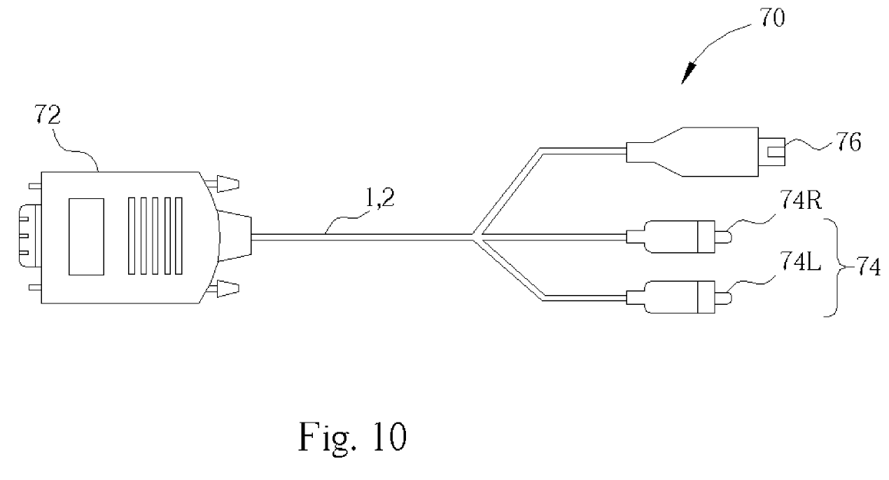

Please refer to FIG. 9 and FIG. 10. FIG. 9 is a schematic diagram of a fifth embodiment of a connection cable 20 according to the present invention. FIG. 10 is a schematic diagram of a sixth embodiment of a connection cable 70 according to the present invention.

In the fifth embodiment, the connection cable 20 is designed to have an integral connector 22 to be installed on one end of the connection cable 20, and three connectors on the other end. The integral connector 22 comprises a first set of pins and a second set of pins (not shown). The connection cable 20 further comprises the first set of transmission lines 1 connected to the first set of pins, and the second set of transmission lines 2 connected to the second set of pins. The three connectors include two audio connectors and one video connector. An audio-L connector 24L and an audio-R connector 24R are connected to the first transmission lines 1. A composite video signal connector 26 is connected to the second set of transmission lines 2 for transmitting composite video signals as shown in FIG. 9. The integral connector 22 is a D-sub connector.

In FIG. 10, the connection cable 70 is designed to have an integral connector 72 to be installed on one end of the connection cable 70, and three connectors on the other. The integral connector 72 comprises a first set of pins and a second set of pins (not shown). The connection cable 70 further comprises the first set of transmission lines 1 connected to the first set of pins, and the second set of transmission lines 2 connected to the second set of pins. The three connectors include two audio connectors and one video connector. An audio-L connector 74L and an audio-R connector 74R are connected to the first set of transmission lines 1. A S video signal connector 76 is connected to the second set of transmission lines 2 for transmitting S video signals. The integral connector 72 is a D-sub connector.

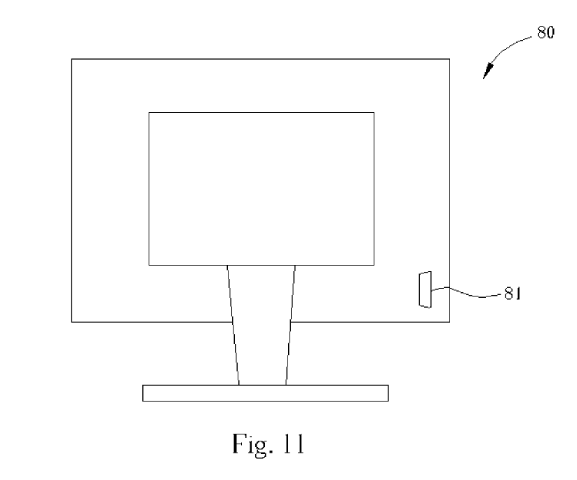

Please refer to FIG. 11, which is a schematic diagram of a connection socket of an A/V device according to the present invention. The A/V device is capable of receiving an audio signal, a first video signal and a second video signal. In the embodiment shown in FIG. 11, the A/V device is a monitor 80. In order to be able connect with the connectors shown in FIG. 5, the monitor 80 is installed with a connection socket 81, which comprises at least a first set of pins for transmitting the audio signal, a second set of pins for transmitting the first video signal, and a third set of pins for transmitting the second video signal. Both of the first and second video signals are selected from two of three signals in a group consisting of a component video signal, a S video signal, and a composite video signal. The monitor 80 is capable of connecting itself to a couple of A/V devices, such as a DVD player or a stereo, with a variety of connectors.

In contrast to the prior art, the present invention can provide a connection cable compatible to connect a variety of A/V inputs/outputs (I/Os), such as an A/V I/O, S video I/O, or component video I/O. The connection cable of the present invention comprises an integral connector, reducing not only the bulk of a control panel of one A/V device, but also time for an user to connect A/V devices in order. In addition, with an unmodified end, the connection cable of the present invention is compatible with modern A/V devices.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

What is claimed is:

1. A connection cable comprising:
an integral connector, comprising a first set of pins, a second set of pins, and a third set of pins;
a first set of transmission lines connected to the first set of pins;
a second set of transmission lines connected to the second set of pins;
a third set of transmission lines connected to the third set of pins;
an audio-L connector and an audio-R connector, both of which are connected to the first set of transmission lines;
a first video signal connector connected to the second set of transmission lines; and
a second video signal connector connected to the third set of transmission lines.

2. The connection cable of claim 1 further comprising a fourth set of transmission lines and a third video signal connector connected to the fourth set of transmission lines, wherein the integral connector further comprises a fourth set of pins connected to the fourth transmission lines.

3. The connection cable of claim 2, wherein the third video signal is selected from one of three signals in a group consisting of a composite video signal, a component video signal, and a S video signal.

4. The connection cable of claim 1, wherein the first video signal is selected from one of three signals in a group consisting of a composite video signal, a component video signal, and a S video signal.

5. The connection cable of claim 1, wherein the second video signal is selected from one of three signals in a group consisting of a composite video signal, a component video signal, and a S video signal.

6. The connection cable of claim 1, wherein the integral connector is a D-sub connector.

7. A connection cable comprising:
an integral connector, comprising a first set of pins, a second set of pins, a third set of pins, and a fourth set of pins;
a first set of transmission lines connected to the first set of pins;
a second set of transmission lines connected to the second set of pins;
a third set of transmission lines connected to the third set of pins;
a fourth set of transmission lines connected to the fourth set of pins;
an audio signal connector connected to the first set of transmission lines;
a component video signal connector connected to the second set of transmission lines;
a S video signal connector connected to the third set of transmission lines; and
a composite video signal connector connected to the fourth set of transmission lines.

8. The connection cable of claim 7, wherein the connector is a D-sub connector.

9. The connection cable of claim 1, wherein the first, second, third, and fourth set of pins are integrated into the integral connector simultaneously.

10. A connection cable comprising:
a D-sub connector, comprising a first set of pins and a second set of pins;
a first set of transmission lines connected to the first set of pins;
a second set of transmission lines connected to the second set of pins;
an audio-L connector and an audio R connector, both of which are connected to the first set of transmission lines; and
a video signal connector connected to the second set of transmission lines for transmitting either a S video signal or a composite video signal.

11. An Audio/Video device (A/V device) capable of receiving an audio signal, a first video signal, and a second video signal, the A/V device comprising:
a connector, which comprises:
a first set of pins for transmitting the audio signal; and
a second set of pins and a third set of pins for transmitting the first and second video signals respectively;
wherein the first and second video signals are selected from two of three signals in a group consisting of a component video signal, a S video signal, and a composite video signal.

12. The A/V device of claim 11, wherein the connector further comprises a fourth set of pins for transmitting a third video signal.

13. The A/V device of claim 12, wherein the first set of pins transmits the audio signal, the second set of pins transmits the component video signal, the third set of pins transmits the S video signal, and the fourth set of pins transmits the composite video signal.
